(19) United States
(12) Patent Application Publication
(10) Pub. No.: US 2018/0056961 A1
(43) Pub. Date: Mar. 1, 2018

(54) BRAKE-BY-WIRE SYSTEM

(71) Applicant: GM Global Technology Operations LLC, Detroit, MI (US)

(72) Inventors: Eric E. Krueger, Chelsea, MI (US); Brandon C. Pennala, Howell, MI (US); Christopher C. Chappell, Commerce Township, MI (US); Alan J. Houtman, Milford, MI (US); Kevin S. Kidston, New Hudson, MI (US); Patrick J. Monsere, Highland, MI (US); Michael C. Roberts, Auburn Hills, MI (US); Paul A. Kilmurray, Wixom, MI (US); Steven J. Weber, Mount Clemens, MI (US)

(21) Appl. No.: 15/250,488

(22) Filed: Aug. 29, 2016

(51) Int. Cl. B60T 13/74; B60T 17/22; B60T 17/18

(52) U.S. Cl. CPC B60T 13/741; B60T 17/22; B60T 17/18; B60T 2270/415; B60T 2270/402; B60T 2270/414; B60T 2270/404

(57) ABSTRACT

A vehicle includes a plurality of electronic brake system (EBS) controllers configured to detect at least one braking event, and a plurality of brake assemblies. Each brake assembly is coupled to a respective wheel of the vehicle and includes an enhanced smart actuator. The enhanced smart actuator further includes an electro-mechanical actuator, and at least one power circuit. The electro-mechanical actuator is configured to adjust a torque force applied to the respective wheel. The at least one electronic power circuit is configured to output a high-frequency switched high-power current drive signal that drives the electro-mechanical actuator. The EBS controllers control a first group of enhanced smart actuators independently from a second group of enhanced smart actuators that exclude the enhanced smart actuators of the first group.

### BACKGROUND

The invention disclosed herein relates to vehicle braking systems and, more particularly, a vehicle including a brake-by-wire (BBW) system.

Current industrial automotive trends to reduce the number of overall mechanical components of the vehicle and to reduce the overall vehicle weight have contributed to the development of system-by-wire applications, typically referred to as X-by-wire systems. One such X-by-wire system that has recently received increased attention is a brake-by-wire (BBW) system, sometimes referred to as an electronic braking system (EBS).

Unlike conventional mechanical braking systems, BBW systems actuate one or more vehicle braking components via an electric signal generated by an on-board processor/controller or received from a source external to the vehicle. In some systems, a BBW system is effected by supplanting a conventional hydraulic fluid-based service braking system with an electrical base system to perform basic braking functions. Such a system is typically provided with a manually actuated back-up system that may be hydraulically operated.

Since BBW systems typically remove any direct mechanical linkages and/or or hydraulic force-transmitting-paths between the vehicle operator and the brake control units, much attention has been given to designing BBW control systems and control architectures that ensure reliable and robust operation. Various design techniques have been implemented to promote the reliability of the BBW system including, for example, redundancy, fault tolerance to undesired events (e.g., events affecting control signals, data, hardware, software or other elements of such systems), fault monitoring and recovery. One design approach to provide fault tolerance which has been utilized in BBW control systems has been to include a mechanical backup system that may be utilized as an alternate means for braking the vehicle.

### SUMMARY

According to a non-limiting embodiment, a vehicle is provided that includes a fault tolerant electronic brake-by-wire (BBW) system. The vehicle includes a plurality of electronic brake system (EBS) controllers configured to detect at least one braking event, and a plurality of brake assemblies. Each brake assembly is coupled to a respective wheel of the vehicle and includes an enhanced smart actuator. The enhanced smart actuator further includes an electro-mechanical actuator, and at least one power circuit. The electro-mechanical actuator is configured to adjust a torque force applied to the respective wheel. The at least one electronic power circuit is configured to output a high-frequency switched high-power current drive signal that drives the electro-mechanical actuator. The EBS controllers control a first group of enhanced smart actuators independently from a second group of enhanced smart actuators that exclude the enhanced smart actuators of the first group.

According to another non-limiting embodiment, a vehicle including a fault tolerant electronic brake-by-wire (BBW) system comprises a plurality of electronic brake system (EBS) controllers configured to detect at least one braking event, and a plurality of brake assemblies. Each brake assembly is coupled to a respective wheel of the vehicle and includes an enhanced smart actuator. The enhanced smart actuator further comprises an electro-mechanical actuator and at least one electronic power circuit. The enhanced smart actuator is configured to adjust a torque force applied to the respective wheel. That at least one electronic power circuit is configured to output a high-frequency switched high-power current drive signal that drives the electro-mechanical actuator. Each EBS controller among the plurality of EBS controllers are in signal communication with each brake assembly among the plurality of brake assemblies.

According to yet another non-limiting embodiment, a method of controlling a fault tolerant electronic brake-by-wire (BBW) system comprises detecting a brake request to brake at least one wheel of the vehicle. The method further includes outputting, via a first electronic brake system (EBS) controller, a first data command signal to control a first group of enhanced smart actuators among a plurality of enhanced smart actuators. The method further includes outputting, via a second EBS controller, a second data command signal to control a second group of enhanced smart actuators among the plurality of enhanced smart actuators, the second group excluding the enhanced smart actuators of the first group. The method further includes controlling each enhanced smart actuator independently from one another using at least one of the first and second data command signals.

The above features and advantages are readily apparent from the following detailed description when taken in connection with the accompanying drawings and claims.

### BRIEF DESCRIPTION OF THE DRAWINGS

Other features and details appear, by way of example only, in the following detailed description of embodiments, the detailed description referring to the drawings in which:

FIG. 1 is a top schematic view of a vehicle having a fault tolerant BBW system in accordance with an embodiment;

FIG. 2 illustrates an enhanced smart actuator integrated in a brake assembly according to a non-limiting embodiment;

FIG. 3A is a schematic view of a BBW system based on a split-EBS controller topology according to a non-limiting embodiment;

FIG. 3B is a schematic view of a BBW system based on a split-EBS controller topology according to another non-limiting embodiment;

FIG. 3C is a is a schematic view of a BBW system based on a full-EBS controller topology according to a non-limiting embodiment;

FIG. 4 is a block diagram illustrating a plurality of EBS controllers included in a BBW system according to a non-limiting embodiment; and

FIG. 5 is a flow diagram illustrating a method of controlling a fault tolerant BBW system according to a non-limiting embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

Various non-limiting embodiments provide a fault tolerant BBW system including a data interface that connects electronic brake system (EBS) controllers and enhanced smart brake actuators. In at least one embodiment, the vehicle includes a plurality of brake assemblies. Each brake assembly integrates therein an electro-mechanical actuator, a power circuit that drives the electro-mechanical actuator, and an actuator controller.

According to a non-limiting embodiment, a first enhanced smart actuator included in a first brake assembly is controlled by a first EBS controller while a second enhanced smart actuator included in a second brake assembly is controlled by a second EBS controller. Each EBS controller may output low-power data command signals to a respective brake assembly via a low-power message-based interface such as, for example, a controller area network (CAN) bus. Accordingly, a flexible BBW system is provided that allows for flexible design choice, wire length reduction, and flexible braking algorithm implementation, while still employing fault tolerance into the system.

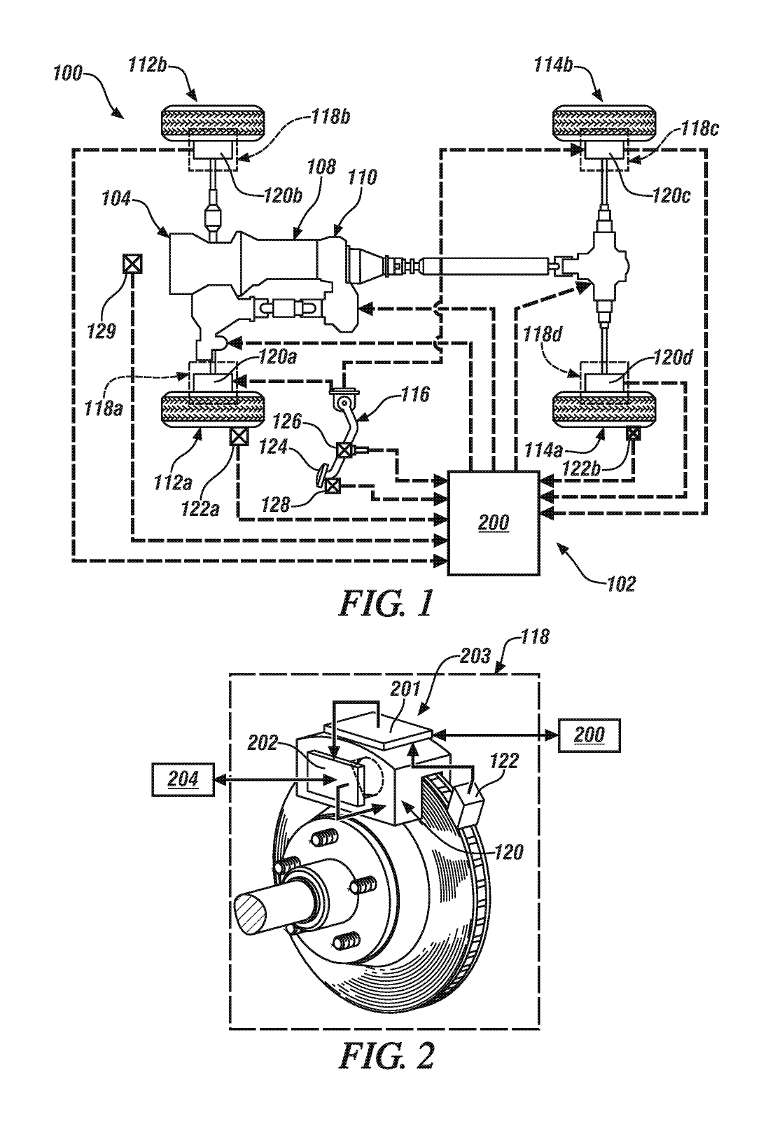

With reference now to FIG. 1, a vehicle 100, including a fault tolerant BBW system 102 configured to electronically control braking of the vehicle 100 is illustrated according to a non-limiting embodiment. The vehicle 100 is driven according to a powertrain system that includes an engine 104, a transmission 108 and a transfer case 110. The engine 104 includes, for example, an internal combustion engine 104 that is configured to generate drive torque that drives front wheels 112a and 112b and rear wheels 114a and 114b using various components of the vehicle driveline. Various types of engines 104 may be employed in the vehicle 100 including, but not limited to a diesel engine, a gasoline engine, a battery electric vehicle including an electric motor, and a hybrid-type engine that combines an internal combustion engine with an electric motor, for example. The vehicle driveline may be understood to comprise the various powertrain components, excluding the engine 104. According to a non-limiting embodiment, engine drive torque is transferred to the transmission 108 via a rotatable crank shaft (not shown). Thus, the torque supplied to the transmission 108 may be adjusted in various manners including, for example, by controlling operation of the engine 104 as understood by one of ordinary skill in the art.

The fault tolerant BBW system 102 comprises a pedal assembly 116, brake assemblies 118a-118d (i.e., brake corner modules), one or more actuator units 120a-120d, one or more one or more wheel sensors 122a and 122b, and an electronic brake system (EBS) controller 200. In at least one embodiment, the actuator units 120a-120d include at least one enhanced smart actuator 203 (FIG. 2). Although two wheel sensors are shown, it should be appreciated that four wheel sensors may be included. Similarly, although four brake assemblies are illustrated, it should be appreciated that a different number of brake assemblies (e.g., two brake assemblies) may be included without changing the scope of the invention.

Referring to FIG. 2, the enhanced smart actuator 203 includes an actuator controller 201, an electronically controlled actuator 120 such as, for example, an electronic brake caliper (e-caliper) 203, and an actuator drive unit 202. The actuator driver unit 202 may include one or more electronic power circuits. Combining the actuator controller 201, actuator 120, and actuator driver unit/power circuits 202 to form an enhanced smart actuator 203 integrated into a single brake assembly 118 offers fast, robust, and diagnosable communication between the EBS 200 and each respective actuator controller 201, while reducing data latency.

The actuator controller 201 selectively outputs a low-power command signal (e.g., low-power digital signal) that initiates the actuator drive unit 202 in response to one or more detected braking events. The actuator controller 201 is also configured to store flashable software to provide flexibility for production implementation. In this manner, the overall number of components and interconnection complexity of the fault tolerant BBW system 102 are reduced compared to conventional BBW systems. In addition, the enhanced smart actuator 203 also eliminates long-distance high-current switching wires, thereby reducing or even eliminating EMI emissions typically found in conventional BBW systems.

Referring again to FIG. 1, the pedal assembly 116 is in signal communication with the EBS controller 200, and includes a brake pedal 124, a pedal force sensor 126, and a pedal travel sensor 128. The EBS controller 200 is configured to detect brake pedal travel and/or braking force applied to the brake pedal 124 based on respective signals output from the pedal force sensor 126, and a pedal travel sensor 128. According to a non-limiting embodiment, the pedal force sensor 126 is implemented as a pressure transducer or other suitable pressure sensor configured or adapted to precisely detect, measure, or otherwise determine an apply pressure or force imparted to the brake pedal 124 by an operator of vehicle 100. The pedal travel sensor 128 may be implemented as a pedal position and range sensor configured or adapted to precisely detect, measure, or otherwise determine the relative position and direction of travel of brake pedal 124 along a fixed range of motion when the brake pedal 124 is depressed or actuated.

The measurements or readings obtained by the pedal force sensor 126 and the pedal travel sensor 128 are transmittable or communicable to one or more EBS controllers 200 or are otherwise determinable thereby as needed for use with one or more braking algorithms stored in memory of the EBS controller 200. The EBS controller 200 is also configured to calculate, select, and/or otherwise determine a corresponding braking request or braking event in response to the detected and recorded measurements or readings output from the wheel sensors 122a-122b. Based on the determined braking request or braking event, the EBS controller 200 outputs a low voltage data command signal that invokes a braking action to slow down the vehicle 100 as discussed in greater detail herein.

The wheel sensors 122a-122b may provide various types of vehicle data including, but not limited to, speed, acceleration, deceleration, vehicle angle with respect to the ground, and wheel slippage. In at least one embodiment, the fault tolerant BBW system 102 may include one or more object detection sensors 129 disposed at various locations of the vehicle 100. The object detection sensors 129 are configured to detect the motion and/or existence of various objects surrounding the vehicle including, but not limited to, surrounding vehicles, pedestrians, street signs, and road hazards. The EBS controller 200 may determine a scenario (e.g., a request and/or need) to slow down and/or stop the vehicle based on the data provided by the pedal unit 116, the wheel sensors 122a-122d, and/or the object detection sensor 129. In response to determining the braking scenario, the EBS controller 200 communicates a braking command signal to one or more brake assemblies 118a-118d to slow or stop the vehicle 100.

In at least one embodiment, the EBS controller 200 outputs a low voltage data signal (e.g., a digital braking command signal) to a driver component or power circuit via a datalink. In at least one embodiment, one or more braking command signals are transmitted across one or more command signal transmission channels or lines initiate operation of a driver that drives an actuator of the brake assembly 118a-118d. The signal transmission channels may be constructed according to various communication protocols including, but not limited to, FlexRay™, Ethernet, and a low-power message-based interface such as, for example, a controller area network (CAN) bus. FlexRay™ is a high-speed, fault tolerant time-triggered protocol including both static and dynamic frames. FlexRay™ may support high data rates of up to 10 Mbit/s.

According to at least one embodiment, the fault tolerant BBW system 102 may also include an isolator module (not shown in FIG. 1) and one or more power sources (not shown in FIG. 1). The isolator module may be configured as an electrical circuit and is configured to isolate wire-to-wire short circuits on a signaling line circuit (SLC) loop. The isolator module also limits the number of modules or detectors that may be rendered inoperative by a circuit fault (e.g. short to ground/voltage, over-voltage, etc.) on the SLC Loop or by a circuit fault of one or more power sources 204a and 204b (e.g. under-voltage, over-voltage, etc.). According to a non-limiting embodiment, if a circuit fault condition occurs, the isolator module may automatically create and open-circuit (disconnect) the SLC loop so as to isolate the brake assemblies 118a-118d from a circuit fault condition. In addition, if a failure of a power source occurs, the isolator module may disconnect the failed power source while maintaining the remaining power sources. In this manner, the fault tolerant BBW system 102 according to a non-limiting embodiment provides at least one fault tolerant feature, which may allow one or more brake assemblies 118a-118d to avoid failure in the event a circuit fault condition occurs in the EBS 200. When the circuit fault condition is removed, the isolator module may automatically reconnect the isolated section of the SLC loop, e.g., the brake assemblies 118a-118d.

In at least one embodiment, the EBS controller 200 includes programmable memory (not shown in FIG. 1) and a microprocessor (not shown). In this manner, the EBS controller 200 is capable of rapidly executing the necessary control logic for implementing and controlling the actuators 120a-120d using a brake pedal transition logic method or algorithm which is programmed or stored in memory.

The EBS controller 200 (e.g., the memory) may be preloaded or preprogrammed with one or more braking torque look-up tables (LUTs) i.e. braking torque data tables readily accessible by the microprocessor in implementing or executing a braking algorithm. In at least one embodiment, the braking torque LUT stores recorded measurements or readings of the pedal force sensor 126 and contains an associated commanded braking request appropriate for each of the detected force measurements as determined by the pedal force sensor 126. In a similar manner, the EBS controller 200 may store a pedal position LUT, which corresponds to the measurements or readings of the pedal travel sensor 128 and contains a commanded braking request appropriate for the detected position of pedal travel sensor 128.

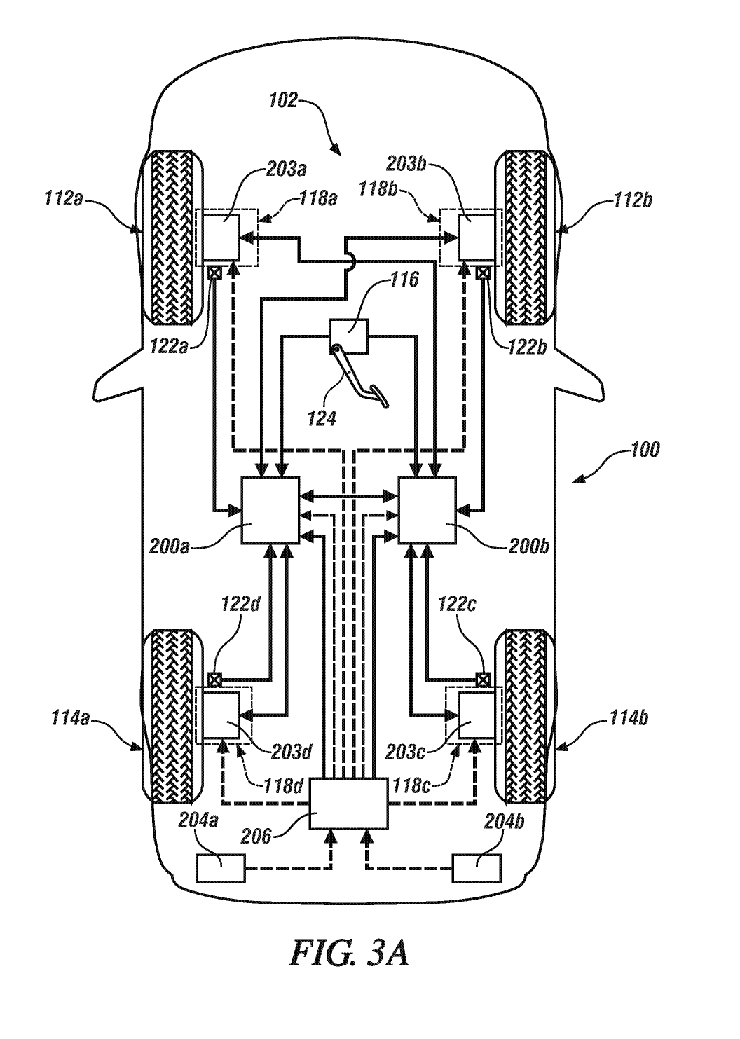

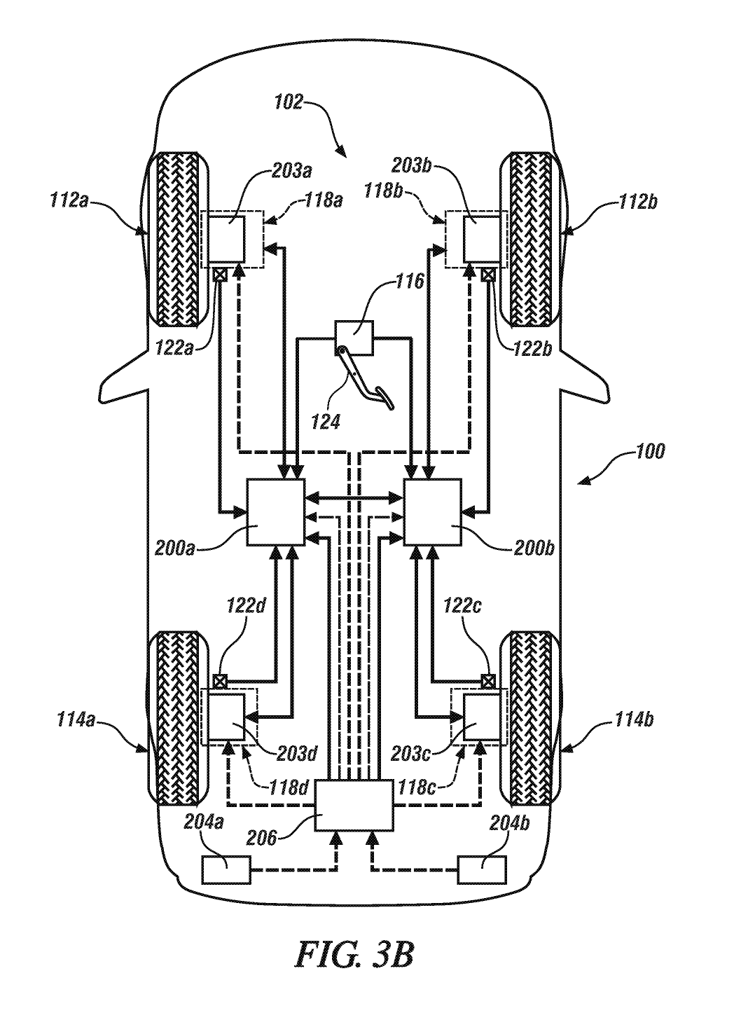

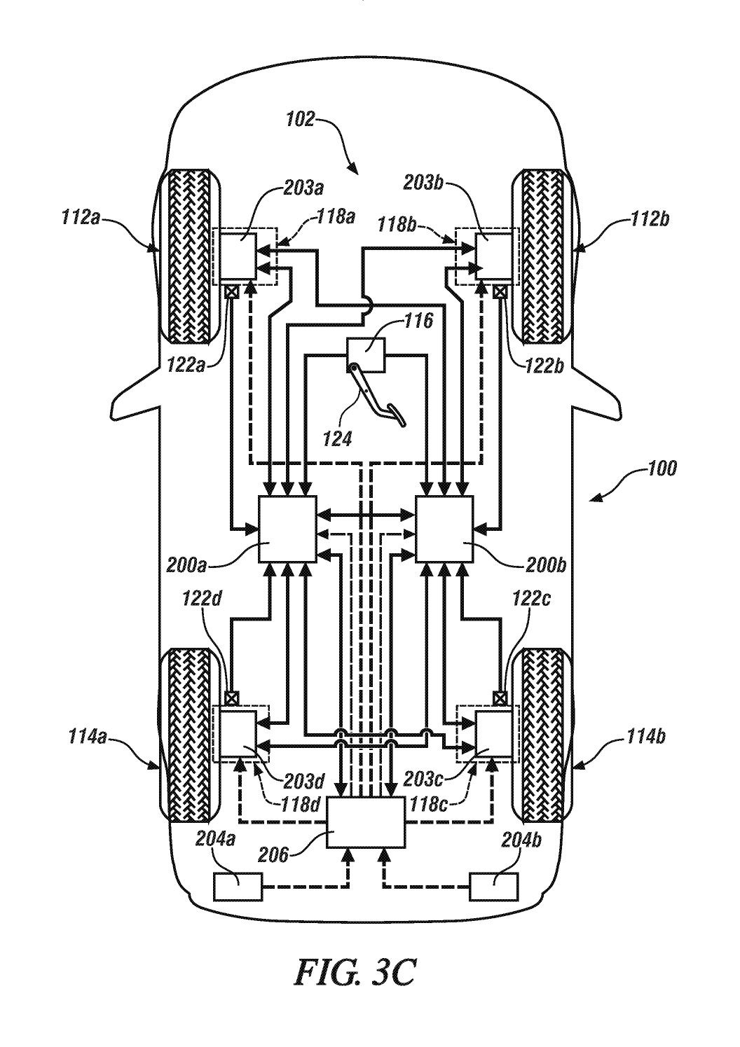

Turning to FIGS. 3A-3C, various embodiments of a BBW system are illustrated. Referring first to FIG. 3A (and also at times referring back to FIG. 2), a fault tolerant BBW system 102 based on a split-EBS controller topology is illustrated according to a non-limiting embodiment. In at least one embodiment, the split-EBS controller topology includes a first EBS controller 200a and a second EBS controller 200b. The first EBS controller 200a is in electrical communication with a first brake assembly 118b configured to brake a first wheel 112b located at a passenger side of the vehicle 100 (e.g., the front passenger-side wheel 112b) and a second brake assembly 118d configured to brake a second wheel 114a located diagonally from the first brake assembly 118b, i.e., at the driver side of the vehicle 100 (e.g., the rear driver-side wheel 114a). Similarly, the second EBS controller 200b is in electrical communication with a third brake assembly 118a configured to brake a third wheel 112a located at the driver side of the vehicle 100 (e.g., the front driver-side wheel 112a) and a fourth brake assembly 118c configured to brake a fourth wheel 114b located diagonally from the third brake assembly 118c, i.e., at the passenger side of the vehicle 100 (e.g., the rear passenger-side wheel 114b). Accordingly, the split-controller topology shown in FIG. 3A may be referred to as a diagonal split controller topology. In this manner, the first and second EBS controllers 200a and 200b may be configured to control a first group of brake assemblies independently from a second group of enhanced smart actuators that exclude the brake assemblies of the first group.

In another embodiment, the split-controller topology may be constructed as a front/rear split controller topology as illustrated in FIG. 3B. In this embodiment, the first EBS controller 200a is in electrical communication with rake assembly 118a located at the front driver-side of the vehicle 100 and bake assembly 118d located at the rear-driver side of the vehicle 100. Similarly, the second EBS controller 200b is in electrical communication with brake assembly 118b located at the front passenger-side of the vehicle 100 and brake assembly 118c located at the rear-passenger side of the vehicle 100.

The brake assemblies 118a-118d control braking torque applied to a respective wheel 112 and 112b and 114a and 114b. Each brake assembly 118a-118d includes, integrated therein, a respective enhanced smart actuator unit 203a-203d. As discussed above with respect to FIG. 2, the enhanced smart actuators 203a-203d include an actuator controller, an electronically controlled actuator such as, for example, an electronic brake caliper (e-caliper), and electronic power circuits combined into a single brake assembly 118a-118d.

The actuator (e.g., motor) operates in response to a high-frequency switched high-power current output by a respective power circuit, and in turn drives the e-caliper which applies a variable (i.e., adjustable) frictional force to slow down a respective wheel 112a and 112b and 114a-114b in response according to a stopping command input by the vehicle driver. The electronic power circuits may include various power electronic components including, but not limited to, h-bridges, heat sinks, application-specific integrated circuits (ASICs), controller area network (CAN) transceivers or temperature or current sensors.

Each electronic power circuit integrated in a respective brake assembly 118a-118d is configured to receive a constant high-power signal and also a low-power command signal. The high-power signal (e.g., high-current) signal is output from one or more power sources 204a and 204b located on the vehicle 100. The low-power command signal is output from one or more EBS controllers 200a and 200b, and may command a respective power circuit to drive the e-caliper, which in turn adjusts the brake force applied to a respective wheel 112a and 112b and 114a and 114b. Since the power circuits are integrated in a respective brake assembly 118a-118d, the power circuits may be located in close proximity of a respective enhanced smart actuator 203a-203d. In this manner, the length of the high-current wires that deliver the switching high-frequency current signals (illustrated as dashed arrows) for driving a respective enhanced smart actuator 203a-203d may be reduced. In at least one embodiment, the power electronics may abut respective enhanced smart actuator 203a-203d so as to completely eliminate conventional high-current wires typically required to deliver switched high-frequency high-current signals to the enhanced smart actuators 203a-203d.

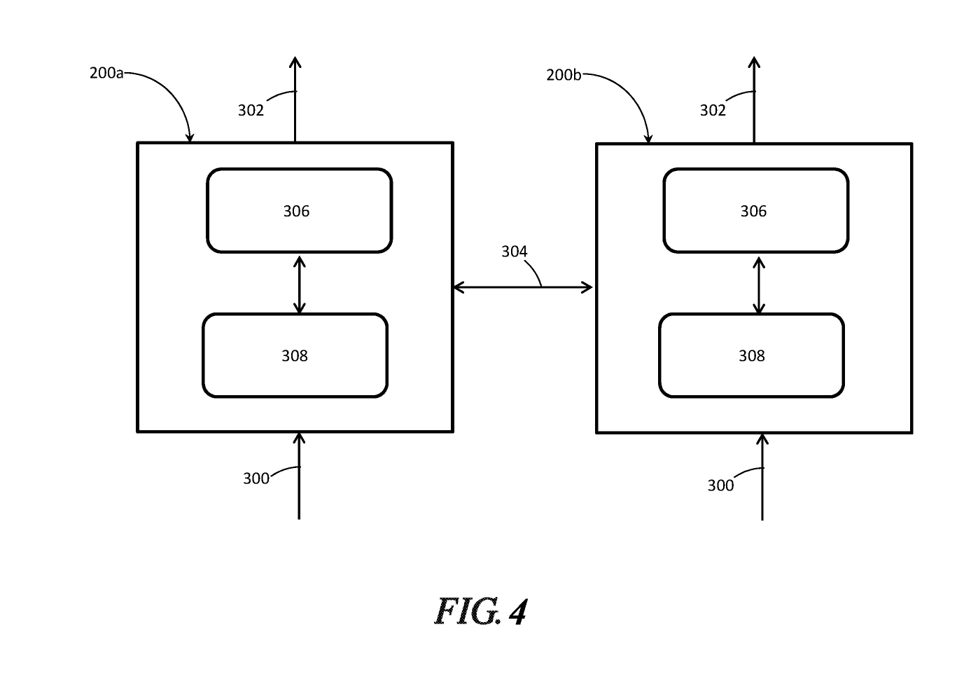

As shown in FIG. 4, the first EBS controller 200a is located remotely from the second EBS controller 200b. Accordingly, the first and second EBS controllers 200a and 200b may be configured to control a first group of brake assemblies independently from a second group of enhanced smart actuators that exclude the brake assemblies of the first group. For example, the first and second EBS controllers 200a and 200b may control a first group of enhanced smart actuators independently from a second group of enhanced smart actuators that exclude the enhanced smart actuators of the first group.

The EBS controllers 200a and 200b receive one or more input data signals 300 delivered by one or more vehicle sensors (e.g., wheel sensors 122a-122d), and output one or more output data signals 302 to one or more electronic power circuits integrated with a respective enhanced smart actuator 203a-203d. In at least one embodiment, the first EBS controller 200a is in electrical communication with the second EBS controller 200b. In this manner, the first and second EBS controllers 200a and 200b may share data with each other. In this manner, the first and second EBS controllers 200a and 200b may also share various data 304 between one another. The shared data includes, for example, detected brake requests, and diagnostic results obtained after performing self-diagnostic tests.

Still referring to FIG. 4, each EBS controller 200a and 200b includes a hardware processor 306 and memory 308 that stores executable instructions including, but not limited to, braking algorithms and self-diagnosis algorithms. The hardware processor 306 is configured to read and execute the instructions stored in the memory 308 so as to control the fault tolerant BBW system 102 as described in greater detail herein.

Returning to FIG. 3A, the EBS controllers 200a and 200b monitor the state of the vehicle 100 based on inputs provided by one or more sensors. The sensors include, but are not limited to, the wheel sensors 122a-122d, and data signals output from the pedal unit 116. Although not illustrated in FIG. 3A, the pedal unit 116 includes various sensors that monitor the pedal 124 including, but not limited to, a pedal force sensor and a pedal travel sensor. The outputs of the pedal force sensor and the pedal travel sensor may be delivered to both the first EBS controller 200a and the second EBS controller 200b to provide output redundancy. Based on the state of the vehicle 100, the first EBS controller 200a and/or the second EBS controller 200b determines whether to invoke a braking event to slow down and/or stop the vehicle 100. When a braking event is determined, the first and second EBS controllers 200a and 200b each output a low power data command signal to a respective brake assembly 118a-118d.

For example, the first EBS controller 200a outputs a braking event data command signal to a first enhanced smart actuator 203b integrated in a first brake assembly 118b and a second enhanced smart actuator 203d integrated in a second brake assembly 118d. The second EBS controller 200b outputs braking event data command signals to a third enhanced smart actuator 203a integrated in a third brake assembly 118a and a fourth enhanced smart actuator 203c integrated in a fourth brake assembly 118c. In at least one embodiment, the EBS controllers 200a and 200b electrically communicate with the enhanced smart actuators 203a-203d via a communication interface. The communication interface includes, but is not limited to, FlexRay, Ethernet, and a low-power message-based interface such as, for example, a controller area network (CAN) bus. In this manner, additional outputs may be conveniently added to the fault tolerant BBW system 102 without requiring additional heavy wiring.

Implementing a low voltage message-based interface also allows the first and second EBS controllers 200a and 200b to conveniently communicate data between one another. In this manner, the first EBS controller 200a can inform the second EBS controller 200b of various detected braking events, and vice versa. The first and second EBS controllers 200a and 200b may also share self-diagnosis data between one another. Therefore, each controller may compare data received from one another in order to diagnose the fault tolerant BBW system 102, e.g., in order to determine whether the fault tolerant BBW system 102 is operating correctly.

The power circuits integrated with each respective enhanced smart actuator 203a and 203d receives a high power input signal (e.g., high power input current) from one or more power sources 204a and 204b. The high power input signal may include a high power current signal ranging from approximately 0 amps to approximately 200 amps. In at least one embodiment, the high power signals are effected through load sharing between the device or when they are isolated and only using one power source.

In response to receiving a braking event data command signal from a respective EBS controller 200a and 200b, each power circuit 202a and 202d is configured to output a high-frequency switched high-power signal to a respective electro-mechanical actuator integrated with a respective enhanced smart actuator 203a-203d. For example, the first EBS controller 200a may output a first braking event data command signal to the first power circuit integrated in a first brake assembly 118b and/or may output a second event braking data command signal to the second power circuit integrated in a second brake assembly 118d. In response to receiving the data command signals, the first power circuit and/or the second power circuit may operate to convert the continuous high power current signal output from the first power source 204a into a high-frequency switched high-current signal which is then delivered to the first enhanced smart actuator 203b installed in the first brake assembly 118b.

In at least one embodiment, the high-frequency switched high-current signal is generated by a pulse width modulation (PWM) circuit included in a power circuit integrated in respective brake assembly 118a-118d. The high-frequency switched high-current signal may have a frequency ranging from approximately 15 kilohertz (kHz) to approximately 65 kHz, and may have a current value of approximately 0 amps to approximately 200 amps. In turn, the high-frequency switched high-current signal drives the electro-mechanical actuator, e.g., a motor, which adjusts the e-caliper so as to apply a braking force on a respective wheel 112a and 112b and 114a and 114b necessary to slow down and/or stop the vehicle 100 as determined by the first EBS controller 200a. Although only a section of the fault tolerant BBW system 102 controlled by the first EBS controller 200a has been described, it should be appreciated that the second section of the fault tolerant BBW system 102 controlled by the second EBS controller 200b may operate in a similar manner as discussed above.

In at least one embodiment, an isolator module 206 is connected between the first and second power sources 204a and 204b, and the remaining electrical system of the fault tolerant BBW system 102. The isolator module 206 is configured to receive constant high power signals generated by the first and second power sources 204a and 204b. Based on the constant high power signals, the isolator module 206 generates a plurality of individual power input signals that are delivered to the EBS controllers 200a and 200b, and the power circuits 202a and 202d. For example, the isolator module 206 outputs first and second constant high voltage power signals to each power circuit 202a and 202d integrated in a respective brake assembly 118a-118d as described in detail above. The isolator module 206 also outputs first and second low power signals that power the first and second EBS controllers 200 and 200b, respectively. In at least one embodiment, the first and second EBS controllers 200a and 200b are in electrical communication with the isolator module 206. In this manner, the first and second EBS controllers 200a and 200b may obtain various diagnostic information including, but not limited to, short circuit events, open circuit events, and over voltage events.

As mentioned above, the isolator module 206 may also be configured to isolate wire-to-wire short circuits on a signaling line circuit (SLC) loop, and is capable of limiting the number of modules or detectors that may be rendered inoperative by a circuit fault on the SLC Loop. The circuit fault may include, but is not limited to, a short-circuit, short-to-ground, and over-voltage. According to a non-limiting embodiment, if a wire-to-wire short occurs, the isolator module 206 may automatically create and open-circuit (disconnect) the SLC loop so as to isolate the brake assemblies 118a-118d from a circuit fault condition. In this manner, the fault tolerant BBW system 102 according to a non-limiting embodiment provides at least one fault tolerant feature, which may allow one or more brake assemblies 118a-118d to avoid failure in the event a circuit fault condition occurs in the EBS 200. When the circuit fault condition is removed, the isolator module 206 may automatically reconnect the isolated section of the SLC loop, e.g., reconnect the brake assemblies 118a-118d.

Referring now to FIG. 3C, a fault tolerant BBW system 102 based on a full electronic brake system (EBS) controller topology is illustrated according to a non-limiting embodiment. The full-EBS controller topology of FIG. 3C operates similar to the split-EBS controller topologies described above with reference to FIGS. 3A and 3B. However, the full-EBS system of FIG. 3C differs in that each EBS controller 200a and 200b is in signal communication with each brake assembly 118a-118d. For example, each EBS controller 200a and 200b electrically communicates with each power circuit and/or actuator controller integrated in a respective brake assembly 118a-118d. In addition, the EBS controllers 200a and 200b may receive data from each individual actuator controller and share the received data between each other. In this manner, one or more enhanced smart actuators 203a-203d (e.g., the actuator controller 201, power circuits 202 and/or e-calibers 120) may be shut-off and/or overridden if their data does not fall in line with data provided by the remaining enhanced smart actuators. Accordingly, the full controller BBW topology may provide additional fault tolerance functionality.

According to at least one embodiment, the EBS controllers 200a and 200b are configured to selectively operate in a split topology mode and a full topology mode based on monitored data. The monitored data includes, but is not limited, diagnostic results obtained in response to self-diagnostic operations executed by the first and/or second EBS controllers 200a and 200b. When operating in the split topology mode, for example, the first EBS controller 200a controls a first group of brake assemblies 118b/118d while the second EBS controller 200b controls a second group of brake assemblies 118a/118c. When operating in the full topology mode, however, either the first EBS controller 200a or the second EBS controller 200b controls both the first group of brake assemblies 118b/118d and the second group of brake assemblies 118a/118c. That is, while operating in the full topology mode, either the first EBS controller 200a or the second EBS controller 200b controls all the brake assemblies 118a-118d.

As mentioned above, the EBS controllers 200a and 200b may transition into the full-EBS topology mode based on diagnostic results obtained in response to performing self-diagnostic testing. For example, the first EBS controller 200a may perform a first self-diagnostic operation and communicates first diagnostic results to the second EBS controller 200b. Similarly, the second EBS controller 200b may perform its own second self-diagnostic operation and can communicate second diagnostic results to the first EBS controller 200a. A full-EBS topology mode may then be initiated if the first diagnostic results and/or the second diagnostic results indicate an error. For example, if the second diagnostic results delivered by the second EBS controller 200b indicate an error, the first EBS controller 200a can command the second EBS controller 200b to enter a stand-by mode or off-line mode invoke the full-EBS topology mode, and in turn control all the brake assemblies 118a-118d included in the fault tolerant BBW system 102. In this manner, if the second EBS controller 200b contains a fault, the fault tolerant BBW system 102 may still be fully operated by the first EBS controller 200a thereby providing a fault tolerance feature.

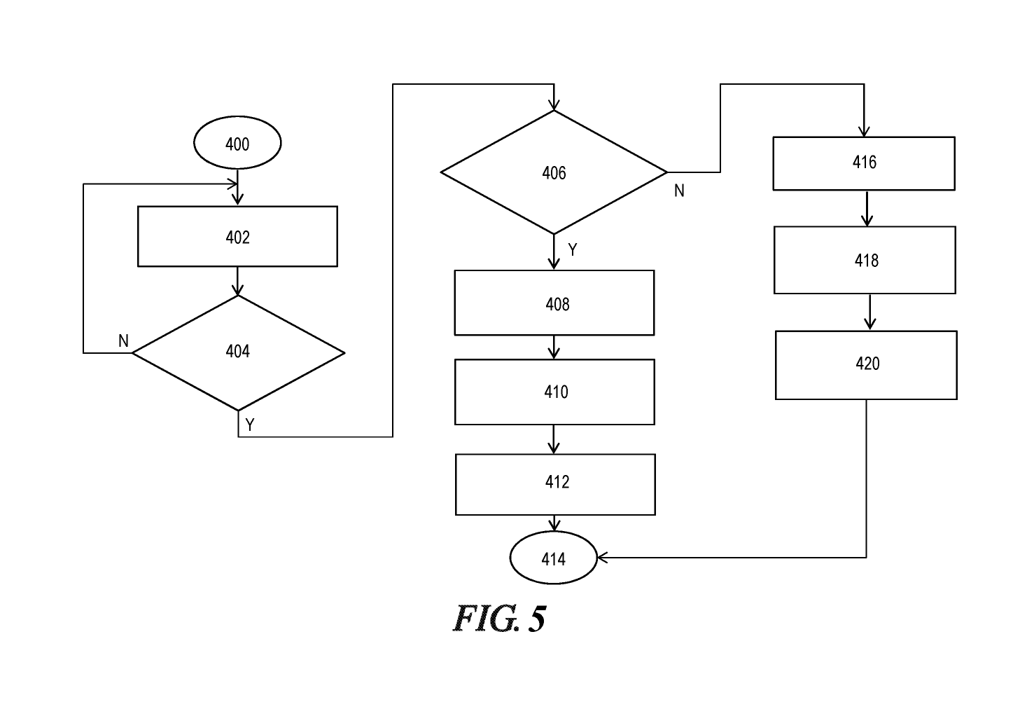

Turning now FIG. 5, a flow diagram illustrates a method of controlling a fault tolerant electronic brake system according to a non-limiting embodiment. The method begins at operation 400 and at operation 402, sensor data is output to a first EBS controller and a second EBS controller. The sensor data may be output from various sensors installed on the vehicle including, but not limited to, wheel sensors, brake pedal sensors, and/or object detection sensors. At operation 404, a determination is made as to whether at least one EBS controller detects a braking event. The braking event is based on the sensor data described above. When no braking event is detected, the method returns to operation 402 and continues monitoring the sensor data.

When at least one of the EBS controllers detects a braking event, however, the first and second EBS controllers communicate with one another so as to compare their respective detected braking event data at operation 406. For example, a first EBS controller may detect a first braking event and may request confirmation that the second EBS controller detected the same or a similar braking event. When the braking event data monitored and generated by the first EBS controller matches or substantially matches the braking event data monitored and generated by the second EBS controller, the method proceeds to operation 408 where the first EBS controller outputs a first data command signal to a first enhanced smart actuator integrated in a first brake assembly, and the second EBS controller outputs a second data command signal to a second enhanced smart actuator integrated in a second brake assembly. In this manner, two separate and individual command signals are output by the first EBS controller and the second EBS controller, respectively. At operation 410, a first power circuit integrated in the first brake assembly drives a first electro-mechanical actuator included with the first enhanced smart actuator in response to receiving the first data signal. Similarly, the second power circuit integrated in the second brake assembly drives a second electro-mechanical actuator included in the first enhanced smart actuator in response to receiving the second data signal. In at least one embodiment, the first brake assembly controls a first wheel and the second brake assembly is located remotely from the first brake assembly and controls a second wheel different from the first wheel. At operation 412, the first electro-mechanical actuator adjusts a first braking torque applied to the first wheel and the second electro-mechanical actuator adjusts a second braking torque applied to the second wheel. In this manner, the vehicle can be slowed or stopped according to the braking event detected by the first and second EBS controllers, and the method ends at 414.

Referring back to operation 406, a scenario may occur where the braking event data monitored and generated by the first EBS controller does not match or substantially match the braking event data monitored and generated by the second EBS controller. In this case, the method proceeds to operation 416 where one of the first EBS controller and the second EBS controller outputs a data command signal to all the brake assemblies. Accordingly, at operation 418, the power circuits integrated in each respective brake assembly drives an associated electro-mechanical actuator (also integrated in the respective brake assembly) based on the data signal output from a single EBS controller. This fault tolerant feature allows operation of the vehicle brake assemblies in the event an EBS controller and/or a section of the BBW (including the sensors communicating with a particular EBS controller) associated with a particular EBS controller experiences a fault. At operation 420, the first actuator adjusts a first braking torque applied to the first wheel and a second actuator adjusts a second braking torque applied to the second wheel, and the method ends at operation 414. In this manner, the individual brake assemblies may be controlled in response to a detected braking event even if one or more of the EBS controllers do not operate according to expected conditions.

As described in detail above, various non-limiting embodiments provide a BBW system including a data interface connecting electronic brake controllers and enhanced smart brake actuators. According to a non-limiting embodiment, a first enhanced smart actuator included in a first brake assembly is controlled by a first EBS controller while a second enhanced smart actuator included in a second brake assembly is controlled by a second EBS controller. Each EBS controller may output low-power data command signals to a respective brake assembly via a low-power message-based interface such as, for example, a controller area network (CAN) bus. Accordingly, a flexible BBW system is provided that allows for flexible design choice, wire length reduction, and flexible braking algorithm implementation, while still employing fault tolerance into the system.

As used herein, the term “module” or “unit” refers to an application specific integrated circuit (ASIC), a field programmable gate array (FPGA), an electronic circuit, an electronic computer processor (shared, dedicated, or group) and memory that executes one or more software or firmware programs, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

While the embodiments have been described, it will be understood by those skilled in the art that various changes may be made and equivalents may be substituted for elements thereof without departing from the scope of the embodiments. In addition, many modifications may be made to adapt a particular situation or material to the teachings of the embodiments without departing from the essential scope thereof. Therefore, it is intended that the disclosure not be limited to the particular embodiments disclosed, but that the disclosure will include all embodiments falling within the scope of the application.

What is claimed is:

1. A vehicle including a fault tolerant electronic brake-by-wire (BBW) system, the vehicle comprising:
a plurality of electronic brake system (EBS) controllers configured to detect at least one braking event;
a plurality of brake assemblies, each brake assembly coupled to a respective wheel of the vehicle and including an enhanced smart actuator, the enhanced smart actuator further comprising:
an electro-mechanical actuator configured to adjust a torque force applied to the respective wheel;
at least one electronic power circuit configured to output a high-frequency switched high-power current drive signal that drives the electro-mechanical actuator,
wherein the plurality of EBS controllers are configured to control a first group of enhanced smart actuators independently from a second group of enhanced smart actuators that exclude the enhanced smart actuators of the first group.

2. The vehicle of claim 1, wherein a first EBS controller among the plurality of EBS controllers is configured to output a first data command signal in response to the at least one braking event to control a first power circuit included in the first group of enhanced smart actuators, and wherein a second EBS controller among the plurality of EBS controllers is configured to output a second data command signal in response to the at least one braking event to control a second power circuit included in the second group of enhanced smart actuators.

3. The vehicle of claim 1, wherein the enhanced smart actuator further comprises an actuator controller configured to detect a braking event and to output a low-power command signal that commands the electronic power circuit to output the high-frequency switched high-power current drive signal.

4. The vehicle of claim 3, wherein the actuator controller generates operational data based on at least one of a torque force applied to a respective wheel and wheel speed of the wheel coupled to the respective brake assembly.

5. The vehicle of claim 4, wherein at least one EBS controller diagnoses operation of a brake assembly based on the operational data output by a respective actuator controller.

6. The vehicle of claim 3, wherein each power circuit is configured to output a high-frequency switched high-power signal that drives the enhanced smart actuator included in a respective brake assembly.

7. The vehicle of claim 2, wherein the first EBS controller is in electrical communication with a first brake assembly configured to brake a first wheel located at a driver side of the vehicle and a second brake assembly configured to brake a second wheel located at a passenger side of the vehicle, and wherein the second EBS controller is in electrical communication with a third brake assembly configured to brake a third wheel located at the driver side of the vehicle and a fourth brake assembly configured to brake a fourth wheel located at the passenger side of the vehicle.

8. The vehicle of claim 7, wherein the first brake assembly is different from the third brake assembly, and wherein the second brake assembly is different from the fourth brake assembly.

9. The vehicle of claim 2, wherein the first EBS controller is in electrical communication with the second EBS controller.

10. The vehicle of claim 1, wherein the plurality of EBS controllers are in signal communication with a respective enhanced smart actuator via a low-power communication bus o.

11. The vehicle of claim 11, wherein the communication bus is at least one of controller area network (CAN) bus, a FlexRay interface and an Ethernet interface.

12. A vehicle including a fault tolerant electronic brake-by-wire (BBW) system, the vehicle comprising:
a plurality of electronic brake system (EBS) controllers configured to detect at least one braking event;
a plurality of brake assemblies, each brake assembly coupled to a respective wheel of the vehicle and including an enhanced smart actuator, the enhanced smart actuator further comprising:
an electro-mechanical actuator configured to adjust a torque force applied to the respective wheel;
at least one electronic power circuit configured to output a high-frequency switched high-power current drive signal that drives the electro-mechanical actuator,
wherein each EBS controller among the plurality of EBS controllers are in signal communication with each brake assembly among the plurality of brake assemblies.

13. The vehicle of claim 12, wherein the plurality of EBS controllers are configured to output a respective data command signal in response to at least one braking event, the data command signal configured to control a power circuit of the enhanced smart actuator included in a respective brake assembly.

14. The vehicle of claim 12, wherein the enhanced smart actuator further comprises an actuator controller configured to detect a braking event and to output a low-power command signal that commands the electronic power circuit to output the high-frequency switched high-power current drive signal.

15. The vehicle of claim 14, wherein the actuator controller generates operational data based on at least one of a torque force applied to a respective vehicle and wheel speed of the wheel coupled to the respective brake assembly.

16. The vehicle of claim 15, wherein at least one EBS controller diagnoses operation of a brake assembly based on the operational data output by a respective actuator controller.

17. The vehicle of claim 14, wherein each power circuit is configured to output a high-frequency switched high-power signal that drives the enhanced smart actuator included in a respective brake assembly.

18. The vehicle of claim 13, wherein the plurality of EBS controllers are in electrical communication with one another.

19. The vehicle of claim 12, wherein the plurality of EBS controllers are in signal communication with a respective enhanced smart actuator via a low-power communication bus.

20. The vehicle of claim 19, wherein the communication bus is at least one of controller area network (CAN) bus, a FlexRay interface and an Ethernet interface.
